(19) United States
(12) Patent Application Publication
(10) Pub. No.: US 2007/0031583 A1
(43) Pub. Date: Feb. 8, 2007

(54) Organic-oil-based food product

(76) Inventor: Francis J. Parker, Green Bay, WI (US)

Correspondence Address: BRINKS HOFER GILSON & LIONE, P.O. BOX 10395, CHICAGO, IL, 60610, US

(21) Appl. No.: 11/200,251

(22) Filed: Aug. 8, 2005

(51) Int. Cl. A23J 1/00

(52) U.S. Cl. 426/656

(57) ABSTRACT

A food product having a variety of consistencies and flavors is described. The product may be made from ingredients that may not derive from animal sources or processes, and may have a consistency ranging from that of a pourable liquid, a cream-cheese spreadable solid or a tofu-like solid. The ingredients include a lipid, which may be soybean oil, soy protein, which may be soy protein isolate, and additional ingredients which may include colorings, emulsifiers, colloids, salt, food acids and sweeteners. The ingredients are mixed together at a high shear rate and then homogenized. The homogenization pressure determines the consistency of the resultant food product.

### TECHNICAL FIELD

The present application relates to a lipid-based food product having controllable consistency, and more particularly to an imitation dairy product which may have the appearance and consistency of cream cheese.

### BACKGROUND

The dietary requirements and preferences of humans vary widely. In some diets, the use of dairy-free, or animal-product-free ingredients while providing a product with taste, texture and appeal of products using animal or dairy products as ingredients, or in the preparation of such ingredients, is desired. In some circumstances the absence of animal or dairy products may need to be certified or otherwise guaranteed by the manufacturer, including the absence of use of animal products of any kind in intermediate manufacturing steps.

Recently several different vegetable-based fat compositions have been developed that do not include dairy proteins. These cholesterol-free fat compositions contain a blend of saturated and polyunsaturated fats and are advertised to alter the ratio of high density and low density lipoproteins in humans. To obtain the effect on lipoproteins, the fat compositions require a specific combination of saturated and unsaturated fatty acids. The fatty acids originate from the vegetable oils, such as soybean oil, corn oil, palm oil, and the like, used in the fat composition. In particular the saturated fatty acids are present in the composition in amounts ranging from 20% to 40% by weight. The saturated fatty acids used in the fat compositions include palmitic, lauric, and myristic acids. The fat compositions also include the polyunsaturated fatty acid, lauric acid, in a concentration of 15% to 40% by weight. While these fat compositions offer a non-dairy protein product, their focus on specific ratios of saturated and polyunsaturated fats may somewhat limit the range of product characteristics that can be produced from the formulations.

Consumer tastes and public health recommendations regarding healthful foods may change over time, and an adaptable food product, having appeal in the areas of smell, taste, mouth feel and consistency, while satisfying dietary preferences or being marketable as meeting dietary restrictions or public health recommendations is desired. Such a food product might have a variety of consistencies at serving temperature, and a controllable content of nutritional components such as saturated, unsaturated and polyunsaturated oils, protein, carbohydrate and the like. Altering the relative quantities of the composition ingredients may result in changes in the product physical characteristics which would be recognized by the consumer. It may be desirable to be able to control the product physical characteristics while varying the composition thereof.

### BRIEF SUMMARY

A food composition is disclosed, having a variety of formulations and consistencies, the ingredients including an organic oil, a soy protein, and additional ingredients which may include food grade acids, salts, colloids, preservatives, pigments, flavorings, sweeteners, emulsifiers and sufficient water to make up the required batch weight. The ingredients are mixed together such that the resultant mixture is treatable by a pressure homogenizer having a pressure capability of between about 1000 psi and about 2000 psi. Depending on the specific formulation and the homogenization pressure, the resultant food product may have a consistency at serving temperature ranging from a pourable liquid, to a spreadable, to a solid. Formulations are disclosed which would permit the representation of the products to consumers as being suitable for vegan diets.

In another aspect, a method of manufacturing is disclosed, the method including: mixing a soy protein and water at a high shear rate; adding an organic oil to the mixture and mixing the resultant mixture at a high shear rate; adding additional dry ingredients and mixing the resultant mixture at a high shear rate; and, treating the resultant mixture by passing the mixture through a pressure homogenizer into a surge tank.

The homogenized mixture may be further treated by, for example, adding flavorings and food particulates, and stirring the contents of the surge tank.

### DETAILED DESCRIPTION

The following non-limiting examples, embodiments and data illustrate various aspects of the invention. It should be understood that these examples, embodiments and data are included for illustrative purposes only and that the invention is not limited to the combinations of materials disclosed herein.

A food product is disclosed, which may be formulated such that it includes no animal or diary ingredients and which may be manufactured to have a look, taste and consistency of food products which contain or were exposed animal product or dairy products. However, other formulations, which are not intended to be marked and marketed as being animal- or dairy-free products may similarly be produced as described herein. Herein, either animal or dairy products are represented by the generic term animal products, unless otherwise stated. The present product is an organic-oil-based material composition, manufacturable with a wide range of consistencies, to serve as a drinkable or pourable liquid, spreadable cream-cheese-like food or a substantially solid food. The product is suitable for flavoring by, for example, fruit flavors, vegetable flavors, fish flavors, and the like.

The food product includes a source of protein, which may be of a form extracted from soybeans, a lipid, which may be an organic oil, a sweetener, emulifiers, acids, salts, flavorings, colorings and water to achieve a consistency such that the resultant mixture may be processed through a pressure homogenizer. The processing pressure, in conjunction with the specific formulation of ingredients results in a product having a wide variety of consistencies, ranging from liquid to solid, at serving temperature. The product may be combined with other ingredients such as fruit and vegetable pieces, and or cooked or cured animal products to form a final product for sale to a consumer. The nature of the ingredients may be restricted so as to permit the product to be represented to the consumer as being a vegan, vegetarian, animal- or diary-free product, or similar, to satisfy either medical dietary restrictions, or consumer preference.

Experiments made by the inventor produced a surprising result that the consistency of the resultant product could be varied over a wide range, from a pourable liquid, to a spreadable cream cheese, to a tofu-like solid by varying the homogenization pressure, while maintaining a fixed product composition. This result means that a wide variety of product consistencies can be obtained for a fixed composition, and it is likewise probable that the same product consistency can be obtained while the relative proportions of the ingredients are changed. This property of the homogenizing pressure for the range of compositions described provides for the satisfaction of a wide variety of consumer preferences while permitting adjustment of the composition to suit dietary or economic needs.

In accordance with an aspect of the invention, a food composition is provided that includes:
(a) a lipid, with a weight percentage of about 15% to about 33%;
(b) soy protein, which may be a soy protein isolate, with a weight percentage of about 6% to about 12%;
(c) evaporated cane juice or other sweetener with a weight percentage of about 4%;
(d) lesser amounts of other ingredients such as food grade acids, salts, colloids, flavorings, preservatives, pigments and emulsifiers; and
(e) water in a sufficient quantity to make up a 100% total weight of the ingredients.

Food grade acids may include citric, lactic, malic and sorbic acids. Food grade salts may include sodium citrate, and potassium citrate or salts of monobasic or polybasic acids such as various phosphate and bicarbonate salts or combinations thereof. Lipids may be selected from the group including safflower oil, soy oil, coconut oil, sunflower oil, corn oil, and mixtures thereof.

In another aspect, a food product is manufactured by mixing the lipid, water and soy protein at high shear, adding the dry ingredients to the aqueous mixture and further mixing at a high shear rate while raising the temperature of the mixture. Flavoring agents are then added and briefly stirred into the mixture. The resultant mixture is then transferred through a pressure homogenizer. The process of homogenization is characterized by the homogenizer pressure being related to the consistency of the resultant product. A homogenizer pressure of about 1000 psi results in a drinkable product; a pressure of about 1500 psi results in a spreadable product; and, a pressure of about 2000 psi or more results in a substantially solid product. The ability to control the physical properties of the resultant product over a wide range by controlling the homogenizer pressure was a surprising result.

The wide variety of consistencies that are achievable by this manufacturing method permit the production of food products having characteristics of many types of edible products such as cream cheese, milk, popsicles and ice cream, smoothies and tofu. The products may be flavored or unflavored. Although the formulation of ingredients disclosed in the examples results in products which will not contain animal-based ingredients, or ingredients produced using animal-based ingredients or processes, similar formulations using such animal-based ingredients are not intended to be excluded, and may be formulated similarly and manufactured in accordance with the methods disclosed herein. For example refined sugar may be substituted for evaporated cane juice.

### EXAMPLES

Equipment to make the examples disclosed will be well known to those skilled in the art. The components or ingredients used in the examples are commercially available from sources well known to those skilled in the art. However, in some instances, specific sources for the equipment or ingredients used have been provided as a convenience. Thus, the use of a specific model of equipment or a specific ingredient from a specific manufacturer is not intended to suggest a limitation on the invention.

Several specific ingredient formulations are disclosed to indicate the characteristics of the materials used in the manufacturing process; a plain style soy cream cheese, and a strawberry flavored soy cream cheese. Table I sets forth the composition of a plain style soy cream cheese. The batch-size weight in Tables I and II relates to the examples illustrating the manufacturing methods described herein, and represents developmental quantities rather than suggesting a batch size in a production application.

TABLE I
Plain Style Soy Cream Cheese Batch Size (190 lbs.)

| Ingredients | Weight % | Weight (lb.) |
|---|---|---|
| Water | 58.850 | 111.82 |
| Soybean oil | 25.825 | 49.07 |
| Soy protein | 8.500 | 16.15 |
| Evaporated Cane Juice | 3.700 | 7.03 |
| Sodium citrate | 0.900 | 1.71 |
| Salt | 0.500 | 0.95 |
| Lactic acid | 0.250 | 0.48 |
| Titanium dioxide | 0.500 | 0.95 |
| Guar/LBG/Xanthan | 0.300 | 0.57 |
| Citric acid | 0.300 | 0.57 |
| Flavor | 0.250 | 0.48 |
| Sorbic acid | 0.175 | 0.33 |
| Total | 100 | 190 |

(The totals are rounded to the nearest unit)

The material composition contains a relatively high percentage by weight of organic oils (in this instance soybean oil), soy protein in the form of a soy protein isolate and evaporated cane juice, with relatively smaller amounts of other ingredients such as food grade acids, salts, starter distillate, and colloids (Guar Gum, Locust Bean Gum (LBG), and Xanthan Gum).

In an alternative embodiment, a strawberry flavored cream cheese spread includes the ingredients listed in Table II.

TABLE II
Strawberry Soy Cream Cheese Batch Size (150 lbs.)

| Ingredients | Weight % | Weight (lb.) |
|---|---|---|
| Water | 47.6097 | 71.41 |
| Soybean oil | 20.8924 | 31.34 |
| Soy protein | 6.8765 | 10.31 |
| Evap Cane Juice | 2.9933 | 4.49 |
| Sodium citrate | 0.7281 | 1.09 |
| Salt | 0.4045 | 0.61 |
| Lactic acid | 0.4045 | 0.61 |
| Titanium dioxide | 0.4045 | 0.61 |
| Guar/LBG/Xanthan | 0.2427 | 0.36 |
| Citric acid | 0.1618 | 0.24 |
| Starter distillate 15× | 0.1011 | 0.15 |
| Sorbic acid | 0.0809 | 0.12 |
| Strawberry puree | | |
| Strawb prep #5718 | 12.0000 | 18.00 |
| Purple Color | 0.1000 | 0.15 |
| Evap Cane Juice | 7.0000 | 10.50 |
| Total | 100 | 150 |

The strawberry soy cream cheese spread using the formulation listed in Table II and the plain style soy formulation listed in Table I differ with respect to the additional ingredients used in the strawberry soy formulation associated with the strawberry characteristics. In the exemplary formulation, a strawberry preparation including strawberry puree and additional evaporated cane juice and food color are added, and the weight percentages of the other ingredients adjusted accordingly. The strawberry preparation #5718 is obtained from Custom Fruits and Flavors, Inc. (Irwindale, Calif.) and the natural food color is a purple carrot extract used to obtain a strawberry-like red color as obtained from Diana Vegetal (Valley Cottage, N.Y.) In accordance with alternative embodiments, preparations including blueberry, chocolate, and vanilla may be used in place of the strawberry preparation.

In the embodiments stet forth above, added dry ingredients include emulsifier, which may be sodium citrate powder, salt, titanium dioxide (TiO2), hydrocolloids, citric acid powder, sorbic acid powder, and granulated evaporated cane juice. Sugar may be used in place of the evaporated cane juice. When sugar is used in place of evaporated cane juice, the resultant product may not be advertised as vegan, as aspects of the sugar making process may use materials containing animal products, such as bone charcoal.

In the exemplary embodiments described above, soy protein was obtained from The Solae Company, St. Louis, Mo., as “Alpha 5800™”, a soy protein isolate. Soy protein isolates are highly refined products made from defatted soy beans, with a protein composition of about 90% or more on a dry weight basis. The taste tends to be “neutral” and most of the carbohydrates are also removed during the processing.

In addition to soybean oil, canola oil, palm oil or other vegetable oils may be used. The soybean oil was non-GMO soybean oil RDB obtained from Columbus Foods (Chicago, Ill.) and contains a mixture of saturated fat, unsaturated fat, and polyunsaturated fat. Saturated fat comprises about 15% of the total fat in the soybean oil, the monounsaturated fat is about 26% and the polyunsaturated fat is about 58% of the total fat. The saturated fat includes about 6% steric acid (18:0), whereas the 26% monounsaturated fat is comprised of oleic acid (18:1). The polyunsaturated fat includes about 50% linoleic acid (18:2) and about 7% linolenic acid (18:3). Fatty acids are commonly identified by a numerical system in which the first number indicates the number of carbon atoms in the fatty acid molecule and the second number indicates the number of carbon-carbon double bonds.

Table III summarizes the fat content of the soybean oil used in the formulations.

TABLE III
Soybean Oil Fat Composition

| Fat | Percent of Total Fat | Percent Fatty Acid |
|---|---|---|
| Saturated Fat | 15% | |
| Steric Acid | | 6% |
| Myristic Acid | | 0% |
| Palmitic Acid | | 9% |
| Monounsaturated Fat | 26% | |
| Oleic Acid | | 26% |
| Polyunsaturated Fat | 58% | |
| Linoleic Acid | | 50% |
| Linolenic Acid | | 7% |

As shown in Table III, the soybean oil used in the formulations contains 15% saturated fat, and 58% unsaturated fat, so that the ratio of saturated fat to unsaturated fat is 15/58 or 0.26.

As shown in Table I the soybean oil constitutes approximately 25.8% of the specific plain style soy spread formulation. When combined with the other ingredients, the fat composition of the final product is shown in Table IV.

TABLE IV
Plain Style Soy Spread Fat Composition

| Fat | Total Percent Fat | Percent Fatty Acid |
|---|---|---|
| Saturated Fat | 3.9% | |
| Steric Acid | | 1.6% |
| Myristic Acid | | 0.0% |
| Palmitic Acid | | 2.3 |
| Monounsaturated Fat | 6.7% | |
| Oleic Acid | | 6.7% |
| Polyunsaturated Fat | 14.9% | |
| Linoleic Acid | | 12.8% |
| Linolenic Acid | | 1.8% |

As shown in Table IV, the polyunsaturated fat is present in an amount substantially greater than the saturated fat on a percentage basis. In the present formulation, the polyunsaturated fat concentration is more than three times the saturated fat concentration.

The ingredients in Tables I and II may be combined in a manufacturing process yielding a variety of product consistencies, ranging from a pourable liquid at room temperature, to a cream-cheese-like consistency, to a tofu-like consistency.

The soybean oil was brought to room temperature in the staging area. Water was placed in the process tank (such as a Likwifier form Breddo, Kansas City, Mo.) and heated to a temperature between about 110° F. and about 120° F. The process tank is equipped with an adjustable speed stirring apparatus for blending ingredients [need model and manufacturer]. Once the water has reached a stable temperature, the stirrer is set to a high shear rate and the soy protein was mixed into the water. After initially mixing the protein at the high shear rate for about 1 minute, the shear rate was reduced to low and the mixing continued for about 5 minutes, while heating the mixture to a temperature of about 155° F. The soybean oil was added to the aqueous soy protein mixture and the resultant mixture stirred at a high shear rate for about 3 minutes. During this period, the temperature of the mixture was maintained at about 155° F.

The shear settings were controlled by a variable frequency drive (VFD) which regulates the frequency of the power supplied to the motor of the shear processor. A “low” shear rate was obtained with a setting between about 20 Hz and about 30 Hz, and a “high” shear rate was obtained with a setting of about 50 Hz and about 60 Hz. Other criteria for obtaining low and high shear rates are also possible, depending on the specific equipment used, the batch size and the specific compositions used.

Once the oil was mixed as described, the remaining dry ingredients were added to the aqueous mixture and the stirring was increased to the high shear rate. The added dry ingredients included emulsifier (sodium citrate powder), salt, titanium dioxide (TiO2), hydrocolloids (which may be one or more of Guar Gum, Locust Bean Gum and Xanthan Gum), salt, citric acid powder, sorbic acid powder, and granular evaporated cane juice. The resultant mixture was stirred at the high shear rate for about 10 minutes. Subsequently, the shear rate was reduced to a low value and the stirring continued while heating the mixture to a temperature of about 164° F.

After mixing in the dry ingredients, the flavoring agents (starter distillate and lactic acid) were added and stirred into the mixture for about 30 seconds. The resultant mixture is transferred through a two-stage pressure homogenizer (APV Products, Model 3DDL, Lake Mills, Wis.) at a pressure of about 1500 psi, when a cream-cheese-like consistency is desired in the product. The homogenized mixture was transferred into a surge tank at a temperature of about 165° F. and stirred intermittently for about 7 to about 8 minutes. The homogenized mixture was then transferred to a filling hopper and the final product was packaged in 0.75 ounce containers at a temperature of at least about 150° F. The containers were sealed and chilled to storage temperature.

A strawberry flavored cream-cheese-like food product may be produced by a method similar to the process described for the plain cream-cheese-like food product. A difference between the two products in the incorporation of a strawberry fruit puree (preparation #5718) and additional evaporated cane juice, and appropriate adjustment of the remaining ingredients, as indicated in Table II.

In the strawberry flavored cream-cheese-like product, a second process tank was used to mix the strawberry fruit puree and the additional evaporated cane juice to form a sweetened strawberry mixture. After intermittent stirring in the second process tank, the strawberry mixture was stirred at high shear for about 30 to about 45 seconds before transferring the strawberry mixture to the surge tank, where the strawberry mixture was mixed with the homogenized mixture produced by the steps previously described for the plain cream-cheese-like spread. The combined mixture was transferred to the filling hopper and packaged in the same manner as the plain cream-cheese-like spread.

In other examples, the pressure of the homogenization step was varied and the consistency of the resultant mixture was observed to vary. In particular, homogenization at a pressure of about 1000 psi resulted in a pourable liquid, a pressure of about 1500 psi resulted in the cream-cheese-like spreads previously described, and a pressure of about 2000 psi or greater resulted in a solid tofu-like consistency. It may therefore be expected that the process may be used with similar ingredients to produce a wide variety of edible food products with varying flavors, colors and consistencies, and these products may further be used as ingredients in other product recipes.

It is therefore intended that the foregoing detailed description be regarded as illustrative rather than limiting, and that it be understood that it is the following claims, including all equivalents, that are intended to define the spirit and scope of this invention.

What is claimed is:

1. A food composition, comprising (by weight):
an organic oil (about 15% to about 33%);
a soy protein (about 6% to about 12%);
additional ingredients further comprising at least one of food grade acids, salts, colloids, preservatives, pigments, flavoring, sweetener or emulsifiers; and,
water sufficient to make up 100% be weight of the ingredients,
wherein a mixture of the organic oil, the soy protein, and the additional ingredients is configured to be treated by a pressure homogenizer.

2. The composition of claim 1 where the pressure homogenizer has a capability of operating at a pressure between about 1000 psi and about 2000 psi or more.

3. The food composition of claim 1, wherein the organic oil comprises soybean oil.

4. The food composition of claim 1, wherein the soy protein comprises a soy protein isolate.

5. The food composition of claim 1, wherein the sweetener comprises at least one of evaporated cane juice or sugar.

6. The food composition of claim 1, wherein a treatment pressure is about 1000 psi, and the consistency of the food composition after homogenization is that of a liquid at room temperature.

7. The food composition of claim 1, wherein a treatment pressure is about 1500 psi, and the consistency of the food composition after homogenization is that of a cream-cheese spread.

8. The food composition of claim 1, wherein a treatment pressure is about 2000 psi or more, and the consistency of the food composition after homogenization is that of a tofu-like solid.

9. The food composition of claim 1, wherein the colloids is at least one of guar gum, locust bean gum (LBG) or Xanthan gum.

10. The food composition of claim 1, wherein the acid is at least one of citric acid or sorbic acid.

11. The food composition of claim 1, wherein the flavoring is at least one of starter distillate or lactic acid.

12. A method of manufacturing a food product, the method comprising:
mixing a soy protein and water at a high shear rate;
adding an organic oil and mixing at a high shear rate;
adding additional dry ingredients and mixing at a high shear rate;
adding flavoring and mixing; and,
transferring the mixture through a pressure homogenizer to a surge tank.

13. The method of claim 12, wherein transferring the mixture through a pressure homogenizer is at a pressure of between about 1000 psi and about 2000 psi or more.

14. The method of claim 12, wherein the pressure is about 1000 psi and the consistency of the homogenized mixture is a pourable liquid.

15. The method of claim 12, wherein the pressure is about 1500 psi and the consistency of the homogenized mixture is a spreadable solid.

16. The method of claim 12, wherein the pressure is about 2000 psi and the consistency of the homogenized mixture is a tofu-like solid.

17. The method of claim 12, further comprising adding a puree to the mixture.

18. The method of claim 12, wherein the homogenized mixture in the surge tank is stirred.

19. The method if claim 18, wherein one or more of a chopped, diced or shredded ingredient comprising one or more of a fruit, a vegetable, a fish, a meat, or a textured vegetable protein is added during the stirring step.
